(19) United States
(12) Patent Application Publication
(10) Pub. No.: US 2006/0216522 A1
(43) Pub. Date: Sep. 28, 2006

(54) Composite material and plastically worked article using the same

(75) Inventor: Yoshizumi Fukuda, Tokyo (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MITSUBISHI STEEL MFG. LTD, TOKYO (JP)

(21) Appl. No.: 10/555,879

(22) PCT Filed: May 14, 2004
(86) PCT No.: PCT/JP04/06907

§ 371 Date: Nov. 4, 2005

(30) Foreign Application Priority Data
May 15, 2003 (JP) 2003-137363

(51) Int. Cl. B32B 27/40

(52) U.S. Cl. 428/423.1; 428/649; 428/411.1

(57) ABSTRACT

The present invention provides a composite material suitable for thermal plastic processing, and having a coating layer that includes a heat-resistant resin having a melting point or pyrolysis temperature of 150° C. or more on the surface of at least one side, and preferably both sides, of a magnesium (alloy) plate. The heat-resistant resin is preferably a thermosetting resin based on polyimide. By using the composite material of the invention, processing with a high degree of processing, such as deep drawing and formation of complex ribs and bosses, can be achieved easily by thermal plastic processing. The present invention also provide a magnesium (alloy) plastic-processing product obtained by plastic processing by using the composite material.

### BACKGROUND OF THE INVENTION

1. Field of the Invention

The present invention relates to a composite material suitable for thermal plastic processing and a plastic-processing product obtained by using the same and in particular to a composite material comprising a resin and magnesium (alloy) that can be easily processed thermal plastically processing and a plastic-processed product using the same.

2. Description of the Related Art

A magnesium plate or a magnesium alloy plate is known to have excellent characteristics such as specific strength and thermal diffusion, but upon fabrication, plastic processing, and particularly cold (room temperature) plastic processing are difficult. Accordingly, the magnesium (alloy) plate is used preferably in products such as bodies of electronic instruments such as laptop computers requiring characteristics such as lightweight, high rigidity, electromagnetic wave shielding properties and heat dissipation. However, the magnesium (alloy)plate is problematic in that to molding with a high degree of processing, such as deep drawing and forming of complicated structural position such as ribs and bosses is difficult, and when complicated structural position are formed, additional steps other than plastic processing, for example a step of cutting and a step of joining a plurality of parts, are necessary after plastic processing, thus leading to higher manufacturing costs and lower productivity.

As methods for improving the plastic processing properties, the following two methods have been used: a method in which thermal plastic processing is performed after a lubricant is applied to at least one of a metallic material to be processed or a mold used in processing; and a method in which thermal plastic processing is performed by interposing a fluorine resin sheet between a metallic material and a metal mold. When the lubricant is applied and then heated, however, there arises another problem that the lubricant may burn and stick to the surface of the mold depending on temperature, thus making complete removal of the lubricant difficult after the processing. Further, the fluorine resin sheet is problematic in that it hardly adheres to a metallic material or a mold because of its low surface energy, is difficult to mold in complex shapes, and is thus unsuitable for processing requiring high processability. In both methods, the metallic material after processing requires treatment for surface protection.

Recently, since the method of using a lubricant and the method of interposing a resin sheet have the aforementioned problems, techniques for improving processability by integrally forming a composite of resin and metal have been proposed as other solution methods for the object of molding a magnesium material with a high degree of processing. For example, Japanese Patent Application Laid-Open (JP-A) No. 2001-315162 proposes a technique wherein a metal plate coated with thermoplastic resin is press-molded and then provided with a rib or boss on the thermoplastic resin layer side by in-mold forming.

JP-A No. 7-124995 proposes a method wherein a metallic part is coated with a heat-resistant rubber adhesive or a hot-melt adhesive based on polyurethane or the like, and a resin is injection-molded on the adhesive layer in a position where a rib or boss is to be formed.

The respective techniques described above require thermoplastic resin to be injection-molded for every piece of a desired part and a treatment for improving the adhesion of the resin to a metallic material. For example, the former requires two steps, that is, a step of plastic processing and a step of in-mold forming, in order to achieve necessary molding, and the latter requires two steps, that is, a step of applying an adhesive onto a predetermined position and a step of in-mold forming, and thus there is a problem that the production process is complex and poor in productivity, materials of the thermoplastic resin to be injection-molded are limited and the like.

When a resin poor in heat resistance suitable for in-mold forming of ribs and the like is used, a uniform coating is difficult to maintained under heating conditions necessary for plastic processing of magnesium (alloy), and cannot be applied to plastic processing involving high-temperature heating.

In consideration of the problems described above, an object of the invention is to provide a magnesium (alloy) composite material suitable for thermal plastic processing (thermal plastic working), which can be easily molded by thermal plastic processing without using a lubricant or the like, even in processing requiring a high degree of processing, such as deep drawing and formation of complex shapes such as ribs and bosses. Another object of the invention is to provide a plastic magnesium (alloy) product obtained from the composite material by thermal plastic processing.

### SUMMARY OF THE INVENTION

As a result of study, the present inventors found that the problem described above can be solved by forming a heat-resistant resin coating on a magnesium (alloy) plate, and the invention was thereby completed.

That is, the composite material of the invention used in thermal plastic processing posses a coating layer including a heat-resistant resin having a melting point or pyrolysis temperature of 150° C. or more disposed on a surface of at least one side of a magnesium plate or a magnesium alloy plate.

The heat-resistant resin is preferably a thermosetting resin, and more preferably a thermosetting polyimide resin.

From the viewpoint of effect, the thickness of the coating layer is preferably in the range of 1 to 250 μm.

The plastic-processed product of the invention possesses a plastic-processing product molded by plastic processing, under heating conditions of 100 to 350° C., and comprising a composite material for use in thermal plastic processing, which includes a coating layer formed of a heat-resistant resin having a melting point or pyrolysis temperature of 150° C. or more disposed on a surface of at least one side of a magnesium plate or a magnesium alloy plate.

In this specification, “magnesium or a magnesium alloy” is sometimes referred to as “magnesium (alloy)”.

The composite material in a sheet form having a heat-resistant resin coating layer serves as a lubricant which when plastic processed using a mold heated for the purpose of obtaining a plastic-processing product (molded product), moderates direct stress from the mold to the surface of a metal plate by being interposed between the metallic material and the mold and reduces the frictional force between the workpiece and the mold by the resin coating layer being softer than the metal. Therefor, a plastic-processing product of complicated shape can be easily obtained from a magnesium (alloy) plate which in the absence of an intervening lubricant or resin sheet, would be difficult to plastic processing.

The resin used for this purpose in the resin coating layer should be superior in heat resistance. That is, the shape of the coating resin layer should be maintained without melting or pyrolysis under heating conditions of plastic processing. The feature “without melting or pyrolysis under the heating conditions of plastic processing” requires that, for example, a heat-resistant resin having a melting point or pyrolysis temperature of 150° C. or more should be used taking it into consideration that the resin coating layer itself may be softened to some degree, but the resin coating layer, if flowing out in a fluidic state during plastic processing or if its functions are deteriorated by pyrolysis or carbonization, cannot achieve the effect of the invention. As the heat-resistant resin, a heat-resistant resin -having a melting point or pyrolysis temperature of 250° C. or more is used more preferably. By the presence of the resin coating layer, thermal plastic processing is made feasible without using a lubricant, thus making it unnecessary to conduct the step of removing a lubricant by degreasing and washing, which is usually carried out after processing.

This resin coating layer may be disposed on at least one side, but is preferably disposed on both sides. Particularly when thermal plastic processing of high processability is conducted with a mold having complex concave and convex regions, the effect of the invention is exhibited on the contact surface between the mold and both sides by adisporsing the resin coating layer preferably on both the sides.

The plastic-processing product processed by using the composite material of the invention is advantageous in that after the plastic processing is finished, the resin coating layer remains on the surface of the plastic-processing product, thus making it unnecessary to conduct surface treatment for preventing oxidation or marring of the surface, which is usually conducted after the plastic processing.

### BRIEF DESCRIPTION OF THE DRAWINGS

FIG. 1 is an illustrative sectional view showing one embodiment of the composite material of the present invention wherein a resin coating layer made of polyimide resin is formed on the surface of a magnesium alloy plate.

FIG. 2 is an illustrative sectional view showing a domed plastic-processing product formed in Example 1 of the invention.

### DESCRIPTION OF THE PREFERRED EMBODIMENT

Hereinafter, the present invention is described in more detail by reference to the examples.

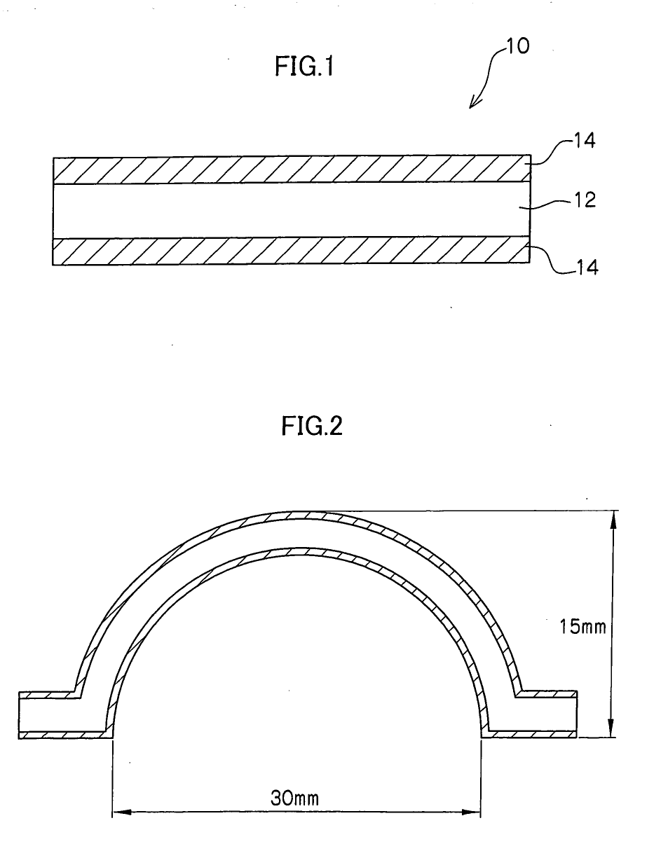

FIG. 1 is an illustrative sectional view showing one embodiment of the composite material 10 of the invention wherein a resin coating layer 14 of 10 μm in thickness made of polyimide resin is formed on both sides of a magnesium alloy plate 12 of 0.1 mm in thickness. To form the resin coating layer on the magnesium (alloy) plate, a known method can be used, and specifically, typical methods include a coating method that involves applying a resin material onto the surface of a magnesium (alloy) plate to form a coating and a lamination method that involves forming a film based on resin and then laminating the film.

The constitution of the composite material of the invention and the method of producing the same are described in this order.

First, magnesium (alloy) is formed into a sheet and used as a substrate. The thickness of this sheet is suitably selected depending on the characteristics of an intended molded product, but is preferably in the range of 0.03 to 5.0 mm from the viewpoint of workability in plastic processing.

The substrate in a sheet form is washed and degreased in a usual manner to remove stains and oil from the surface. Then to improve the adhesion of the substrate to a resin coating layer to be formed, the surface of the substrate may be subjected to, for example, pretreatment such as coating with an adhesion improver or treatment for roughening the surface.

In this embodiment, the case where the substrate in a sheet form is used as a material to be subjected to plastic processing will be described, however the material to be processed is not limited thereto, and a linear magnesium (alloy) base material can be subjected to plastic processing to form a coil.

When the resin coating layer is formed by a coating method on the surface of a base material, of a heat melting method that involves applying heat-molten resin in a usual manner onto the surface of the substrate and then cooling it to room temperature to form a resin coating layer, or a solution coating method that involves drying a resin solution (dispersion) having a resin dispersed or dissolved in a solvent thereby removing the solvent, to form a resin coating layer can be used.

In the method of applying a liquid resin composition, various techniques can be used. Examples of those techniques include spray coating, dip coating, bar coater coating, roll coater coating, curtain coating, air knife coating, blade coating and the like.

In the invention, a thin and uniform resin coating layer is preferably arranged from the viewpoint of the effect, and for this purpose, bar coater coating, roll coater coating and blade coating are particularly preferable among those techniques mentioned above.

On the other hand, when the resin can be applied as a powdery composition onto the surface of a base material, the resin is applied by electrostatic powder coating and then baked in an oven to form a coating.

Preparation of a coating by electrodeposition coating can also be preferably used.

When the heat-resistant resin layer is formed by the lamination method, a resin film is bonded to a substrate by lamination to form a resin coating layer, wherein an adhesive may be applied if necessary onto the surface of the substrate. The resin film used in lamination is formed in a thickness adapted to the thickness of the intended resin coating layer by a known method adapted to the characteristics of the resin used. In the step of laminating the resulting resin film on a substrate, the resin film is preferably heated and pressure-bonded to improve the adhesion of the resin coating layer. The heating temperature can be suitably selected depending on the characteristics of the resin. Usually, the substrate and the resin film to be laminated thereon are heated and pressure-bonded with a pair of press rolls, at least one of which is provided with a heating means.

The thickness of the resin coating layer can be suitably determined depending on the properties of an intended molded product, the thickness of the substrate, a shape processed, and the type of resin used. By forming a thin and uniform resin coating layer, plastic processing is facilitated and, the metal plate is prevented from cracking during in plastic processing. Further physical properties such as vibration properties and feel of the material, such as metallic gloss and a tactile sensation of the magnesium (alloy) after processing do not deteriorate. Thus in consideration of these advantages together with improvement in workability, the thickness of the resin coating layer is preferably 1 to 250 μm.

The resin coating layer may be disposed on at least one side of a magnesium (alloy) substrate, but is preferably disposed on both sides of the substrate. Since magnesium (alloy) is easily oxidized, various countermeasures should be taken to protect its surface during storage before processing, and after processing, but when the resin coating layer is present on the surface as shown in the invention, the coating layer prevents the air (oxygen) from contacting directly with the surface of the substrate to prevent oxidation, thus making it unnecessary to regulate a handling atmosphere, causing another advantage of further improving in handling properties.

In the invention, the resin for forming the heat-resistant resin coating layer should maintain the shape of the resin coating layer even under the temperature condition of plastic processing, and therefore, the heat-resistant resin having a melting point or pyrolysis temperature of 150° C. or more should be used, but under these conditions, the surface may softened.

The heat-resistant resin may be thermoplastic resin or thermosetting resin insofar as it has a melting point or pyrolysis temperature of 150° C. or more, but the thermosetting resin is preferably used because this resin is liquid at ordinary temperatures, can easily form a thin and uniform coating by bring heated, and hardly changes its coating properties even when heated in plastic processing.

Hereinafter, examples of the resin suitable for forming the heat-resistant resin coating layer in the invention are described, but the invention is not limited thereto.

The thermosetting resin includes epoxy resin, silicone resin, polyimide resin and the like.

In particular, the surface of magnesium (alloy) is easily oxidized so that breakage may occur in oxidized sites at the time of heating processing, or when the surface oxide layer is removed after the processing, the strength of that region may be lowered, and thus the surface of the metal is preferably protected by a resin coating layer that is difficult to change even under the heating conditions at the time of plastic processing and having sufficient hardness and stretchability, and from this viewpoint, polyimide resin excellent in self-lubricating properties is used preferably in the resin coating layer. The polyimide resin is also advantageous in that it has transparency to make use of metallic gloss on the surface of the magnesium (alloy) plate, and even upon combustion, dose not generated toxic substances such as dioxin.

In particular, polyimide resin which can be obtained from resin having a pyrolysis temperature of higher than 300° C. by introducing an annular structure into the rasins molecule is preferable, and block copolymer polyimide obtained by polycondensation of tetracarboxylic dianhydride with aromatic diamine in the presence of an acid catalyst consisting of a lactone compound and a base can be preferably used.

Thermoplastic resin can also be used in the invention insofar as it is heat-resistant resin used widely as engineering plastics. Specific examples include polyamide resin, polyphenylene sulfide resin, polyether ketone resin, polyether imide resin, polyamide imide resin, and fluorine resin.

From these resins, the resin constituting the resin coating layer of the invention can be selected depending on the object. These resins can be used alone or as a mixture of two or more. Further a resin to which additives such as a heat resistance improver are added may be used, or a resin whose heat resistance is improved by improving the density of crosslinkages by adding a crosslinking agent may also be used.

The composite material of the invention thus obtained is subjected to plastic processing to give a molded product (plastic-processed product). In the step of plastic processing, the composite material is set in a mold so as to allow its resin coating layer to contact with the mold, and then metallic press-molded while the mold is being heated to 100 to 350° C., to give a desired plastic-processing product of magnesium (alloy). The plastic-processing product thus obtained has improvements in plastic workability of the magnesium (alloy) plate, and thus deep drawing and molding of regions having fine members such as ribs and bosses can be effected by integral molding using thermal plastic processing.

### EXAMPLES

Hereinafter, the present invention is described in more detail by reference to the Examples, but the invention is not limited thereto.

### Example 1

The surface of a magnesium alloy plate (AZ31) of 0.1 mm in thickness was degreased, acid cleaning, and then coated with polyimide resin (weight-average molecular weight, 70,000; pyrolysis temperature, 420° C.) by a coating method and cured by heating at 250° C. for 30 minutes, whereby a composite material 10 comprising a polyimide resin coating layer 14 of 10 μm in thickness formed on both sides of a magnesium alloy plate 12, as shown in FIG. 1, was obtained.

The composite material 10 was press-molded with a mold heated at 300° C., to form a domed product of 30 mm in diameter and 15 mm in height for speaker diaphragm, as shown in FIG. 2.

When the outward appearance of the product after molding was visually observed, it was found that the product was free of cracking and did not exhibit deterioration in the outward appearance due to plastic processing, to show good plastic workability.

### Comparative Example 1

A composite material comprising a polyester resin coating layer formed on both sides of a magnesium alloy plate was obtained in the same manner as in Example 1 except that polyester resin (weight-average molecular weight, 40,000; melting point, 100° C.) was used as the resin in the resin coating layer.

This composite material was subjected to plastic processing in the same manner as in Example 1.

When the outward appearance of the product after molding was visually observed, fusion and partial release of the resin coating layer and oxidization of the surface of the magnesium alloy were observed.

According to the invention, there can be provided a resin/magnesium (alloy) composite material which can be easily molded by thermal plastic processing without using a lubricant or the like, even in processing requiring a high degree of processing, such as deep drawing and formation of complex shapes such as ribs and bosses. Further, by using the composite material of the invention, a thermal plastic-processing product of magnesium (alloy) in a complex shape can be easily obtained, and surface treatment after processing can be omitted.

1. A composite material for use in thermal plastic processing, the composite material comprising a coating layer including a heat-resistant resin having a melting point or pyrolysis temperature of 150° C. or more disposed on a surface of at least one side of a magnesium plate or a magnesium alloy plate.

2. A composite material for use in thermal plastic processing according to claim 1, wherein the heat-resistant resin is a heat-resistant resin having a melting point or pyrolysis temperature of 250° C. or more.

3. A composite material for use in thermal plastic processing according to claim 1, wherein the heat-resistant resin is a thermosetting resin.

4. A composite material for use in thermal plastic processing according to claim 1, wherein the heat-resistant resin is a thermosetting resin selected from the group consisting of epoxy resin, silicone resin,and polyimide resin.

5. A composite material for use in thermal plastic processing according to claim 4, wherein the thermosetting resin is polyimide resin.

6. A composite material for use in thermal plastic processing according to claim 4, wherein the thermosetting resin is polyimide resin having an annular structure in its molecule and having a pyrolysis temperature of higher than 300° C.

7. A composite material for use in thermal plastic processing according to claim 1, wherein the heat-resistant resin is a thermoplastic resin selected from the group consisting of polyamide resin, polyphenylene sulfide resin, polyether ketone resin, polyether imide resin, polyamide imide resin, and fluorine resin.

8. A composite material for use in thermal plastic processing according to claim 1, wherein the thickness of the coating layer including the heat-resistant resin is in the range of 1 μm to 250 μm.

9. plastic-processing product molded by plastic processing, under heating conditions of 100° C. to 350° C., and comprising a composite material for use in thermal plastic processing, which includes a coating layer formed of a heat-resistant resin having a melting point or pyrolysis temperature of 150° C. or more disposed on a surface of at least one side of a magnesium plate or a magnesium alloy plate.

10. A plastic-processing product according to claim 9, wherein the heat-resistant resin is a heat-resistant resin having a melting point or pyrolysis temperature of 250° C. or more.

11. A plastic-processing product according to claim 9, wherein the heat-resistant resin is a thermosetting resin.

12. A plastic-processing product according to claim 9, wherein the plastic processing is a processing that performs metal press molding while heating a mold to 100° C. to 350° C.
